(19) United States
(12) Patent Application Publication
(10) Pub. No.: US 2020/0034083 A1
(43) Pub. Date: Jan. 30, 2020

(54) JOB MANAGER, JOB MANAGEMENT SYSTEM, PRINTER, MULTIFUNCTION MACHINE, PRINTING SYSTEM, JOB MANAGEMENT METHOD, AND STORAGE MEDIUM

(71) Applicant: SHARP KABUSHIKI KAISHA, Sakai City (JP)

(72) Inventor: YUHSUKE NAGAI, Sakai City (JP)

(21) Appl. No.: 16/506,350

(22) Filed: Jul. 9, 2019

(30) Foreign Application Priority Data
Jul. 27, 2018 (JP) 2018-141295

(51) Int. Cl. G06F 3/12; H04L 12/26

(52) U.S. Cl. CPC G06F 3/122; G06F 3/1257; H04L 43/103; G06F 3/1287; G06F 3/1259; G06F 3/1207; G06F 3/1261

(57) ABSTRACT

A print manager includes a saving section that, if a job is received while the amount of free space for a job in a spooler area is less than a first predetermined value, saves the job to another device, a retrieving section that, in accordance with a predetermined polling interval, retrieves the job temporarily saved on the other device back to the job manager from the other device, and a job output section that outputs, to an executing device, the job retrieved back from the other device.

### BACKGROUND

### 1. Field

The present disclosure relates to a job manager, a job management system, a printer, a multifunction machine, a printing system, a job management method, and a storage medium.

### 2. Description of the Related Art

A function called spool printing is a common feature for printers including a storage device such as a hard disk drive (HDD). In spool printing, a print job is temporarily stored into a spooler provided in the storage device before printing of the print job is started. With the spool printing function, even when too many print jobs to be processed in a short amount of time are sent from multiple information processors such as personal computers, these print jobs can be processed without being discarded.

There may be a case where, for example, a new print job is received even when the printer has stopped operation due to running out of paper and processing of previously received print jobs is stagnating. If this state continues, and the amount of space for print jobs in the spooler area of the storage device runs out, sending of print jobs by the information processors may naive to be put on hold, or print jobs sent from the information processors may nave to be discarded.

This is true not only for print jobs but also for other types of jobs.

Japanese Unexamined Patent Application Publication No. 2014-124925 discloses an image processing apparatus that generates intermediate data based on image data, and generates bitmap image data based on the intermediate data. With the image processing apparatus, when the storage device runs short of space for storing intermediate data, bitmap image data is generated from image data residing in a removable drive to thereby avoid use of the storage device. Unfortunately, although the technique according to Japanese Unexamined Patent Application Publication No. 2014-124925 helps avoid running out of free space in the storage device, if print requests are received one after another, there may be some data that is unable to be printed.

Japanese Unexamined Patent Application Publication No. 2011-008536 discloses, among other things, an image forming apparatus that prints a cover sheet based on the header part of a received email, and the body of the email, and an image forming apparatus that prints an attached file based on a print instruction written in the subject of the received email. Unfortunately, Japanese Unexamined Patent Application Publication No. 2011-008536 contains no disclosure as to how to handle a situation where emails arrive at a frequency that exceeds the printing capacity of the image forming apparatus.

It is desirable to have the ability to, even when too many jobs to be absorbed by a spooler are received from an information processor, continue receiving jobs from the information processor, and further output the jobs to a device that executes the jobs without discarding the jobs.

### SUMMARY

According to an aspect of the present disclosure, there is provided a job manager including a saving section that, if a job is received while the amount of free space for a job in a spooler area is less than a first predetermined value, saves the job to another device, a retrieving section that, in accordance with a predetermined polling interval, retrieves the job temporarily saved on the other device back to the job manager from the other device, and a job output section that outputs, to an executing device, the job retrieved back from the other device.

### BRIEF DESCRIPTION OF THE DRAWINGS

FIG. 1 is a conceptual diagram illustrating the configuration of a printing system according to an embodiment of the present disclosure;

FIG. 2 is a flowchart for explaining operation of a printer according to a first embodiment of the present disclosure upon receiving a print job;

FIG. 3 is a flowchart for explaining operation of the printer according to the first embodiment of the present disclosure when sending an email;

FIG. 4 is a flowchart for explaining operation of the printer according to the first embodiment of the present disclosure when, inquiring an email server;

FIG. 5 is a flowchart for explaining operation of a printer according to a second embodiment of the present disclosure when inquiring an email server;

FIG. 6 is a flowchart for explaining operation of a printer according to a third embodiment of the present disclosure when inquiring an email server;

FIG. 7 is a functional block diagram illustrating a printing system according to a fourth embodiment of the present disclosure that includes a printer and an email server connected to the printer;

FIG. 8 is a conceptual cross-sectional view of a multifunction machine according to a sixth embodiment of the present disclosure; and

FIG. 9 is a functional block diagram of the multifunction machine according to the sixth embodiment of the present disclosure.

### DESCRIPTION OF THE EMBODIMENTS

Embodiments of the present disclosure will be described below in detail with reference to the drawings.

### First Embodiment

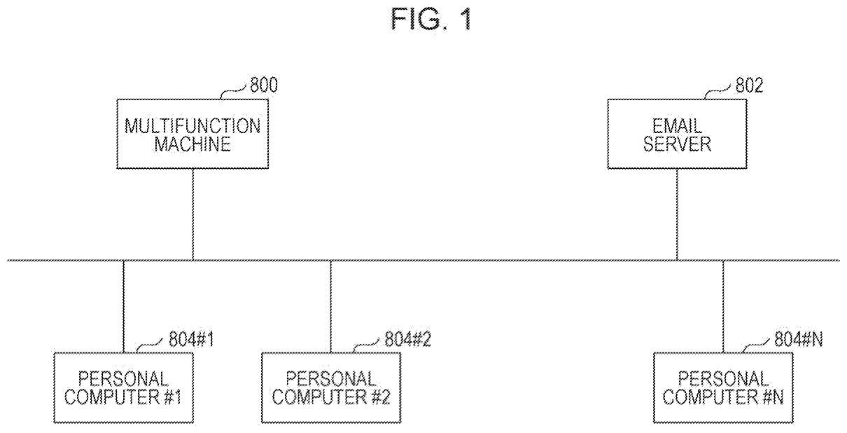

A printing system according to an embodiment of the present disclosure is illustrated in FIG. 1. In the printing system, a multifunction machine 800 receives a print job from personal computers 804#1 to 804#N to perform spool printing. At this time, if the amount of free space in the spooler area has decreased, the multifunction machine 800 temporarily saves the received print job to an email server 802, and executes printing after retrieving back the saved print job.

In spool printing, for example, a printer in the printing system receives a print job or print data from an information processor via a network or a USB cable, or directly from a USB memory.

In another method, print data is printed by use of an email as disclosed in Japanese Unexamined Patent Application Publication No. 2011-008536. According to this method, the user attaches print data to an email, or writes information to be printed into the body of an email, and sends the email to an email address assigned to a printer. The printer then checks the email server for the presence of any email addressed to the printer. If any email addressed to this printer has arrived at the email server, the printer receives the email from the email server. The printer performs printing if the received email contains attached print data, or if the received email contains information to be printed that is written in the body of the email.

A multifunction machine that functions as a printer in the printing system typically includes a scanner function. In addition to the scanner function, such a multifunction machine often includes a network setting that allows scanned data to be sent to the personal computer of a specific user, an FTP server, an SMB server, or the email address of a specific user. In any case, by adding an email creation function to such a multifunction machine having an email transmission function, an email created by the email creation function can be transmitted. Alternatively, the same can be accomplished by adding an email creation function and an email transmission function to the printer.

The following describes operation during spool printing.

(1) If there is no job currently being printed or spooled at the time when a print job is received, the received job is analyzed, and a printing image used for printing is generated by an image forming unit.

(2) In the presence of any currently executed job, if there is enough free space in the spooler area of a storage device for storing the received job, the received job is stored into the spooler area, and placed on standby as the next job waiting to be printed after a preceding job (preceding stored job).

(3) In the absence of enough free space in the spooler area of the storage device, if the current state of the printer is such that the printer is able to send an email, an email is generated to execute a process such as saving the data of the print job to the email.

(4) If the printer is unable to send an email, the job is cancelled after the elapse of a reception timeout period as in the conventional manner.

The following describes operation for a case where email data is generated due to insufficient space in the spooler area.

(1) If email printing has been set up for the printer, and the printer is able to receive email data from the email server as a print job, email data is generated for an email address assigned to the printing system, and the email data is sent after extending the interval at which to make inquiry to the email server.

(2) For a case where email printing has not been set up for the printer, if a print job contains information about the user who has sent the print job, such as a user name or a password, and if the email address of the user can be identified based on information such as

address book information retained by the printer, or

inquiry made to an LDAP server set for the printer, an email is sent to the email address of the user that contains, in the body of the email, information indicating that the print job has not been printed. If the size of the print job is small, it is also possible to attach the print job to the email, and prompt the print job to be resent.

The following describes operation performed when the timing for inquiring the email server arrives.

(1) It is checked whether a print job that has not been able to be stored into the spooler area has been saved via an email, and if an email with saved print job data has not been issued, an inquiry to the email server is executed in a normal manner.

(2) If an email with saved data has been issued, it is checked how much free space is available in the spooler area. If a preceding job has been already processed and there is now enough free space, the inquiry interval to the email server is returned to the original interval, and an inquiry to the email server is executed.

(3) If there is not enough free space in the spooler area, an inquiry to the email server is skipped, and it is waited until the next inquiry timing arrives.

In this regard, if it is not possible to store a received print job into the spooler area due to insufficient free space in the storage device while spool printing is executed, such a print job would normally be discarded after the elapse of a timeout period on the information terminal (PC) that has sent the print job. By contrast, according to the above-mentioned configuration, such a print job is transferred to the email server.

As described above, a print job not successfully stored into the spooler area is sent to the email address of the user who has sent the print job. The sending user can be thus notified of the status of the printing system (the reason why printing is not possible), and prompted to give an instruction to perform printing again. This leads to enhanced user convenience.

Next, operation according to the first embodiment will be described with reference to the drawings.

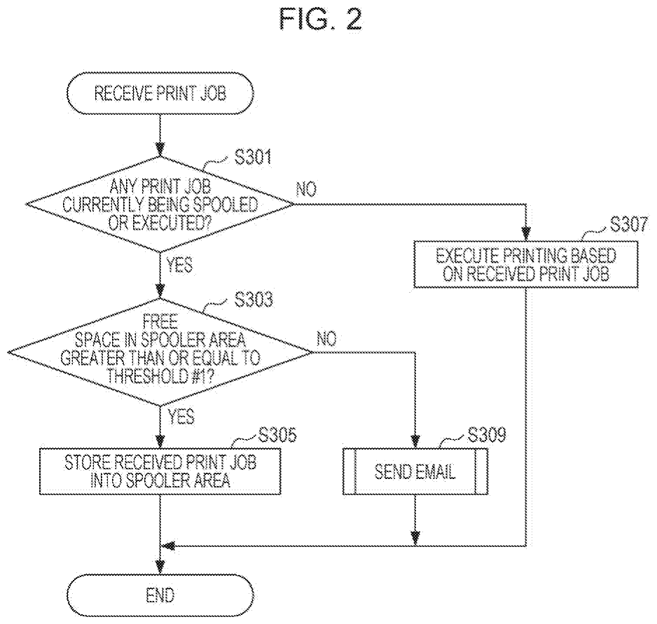

First, operation during spool printing will be described with reference to FIG. 2.

Upon receiving a print job from an information processor, it is determined whether there is any print job currently being spooled or executed, and if not (NO at step S301), printing is immediately executed based on the received print job (step S307).

If there is any print job currently being spooled or executed (YES at step S301), it is determined whether the amount of free space in the spooler area is greater than or equal to a threshold #1, and if so (YES at step S303), the received print job is stored into the spooler area (step S305).

If the amount of free space in the spooler area is less than the threshold #1 (NO at step S303), a process for sending am email is performed (step S309).

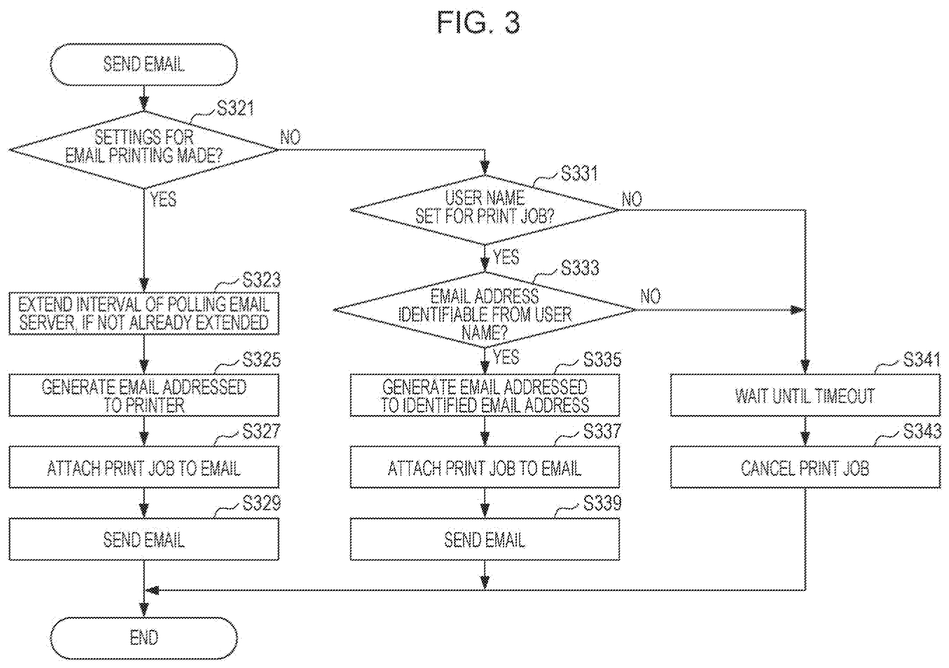

FIG. 3 illustrates step S309 in detail.

First, it is determined whether settings for email printing have been made (step S321). Email printing refers to a function whereby a printer receives, from an email server, an email addressed to the printer that has an attached print job and contains a description instructing that printing be executed, and the printer then executes printing based on the received email. To receive an email from the email server, a printer inquires the email server in accordance with a polling interval to check whether any email addressed to the printer is stored on the email server. If there is any such email, the printer receives the email from the email server. Settings for email printing include a setting for accessing the email server and receiving an email from, the email server, and a setting for executing printing based on the received email.

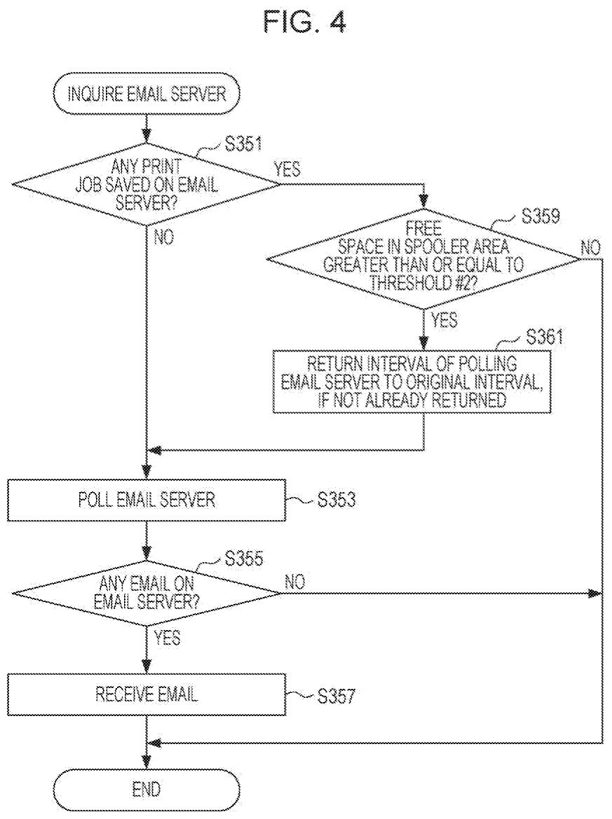

If settings for email printing have been made (YES at step S321), the interval of time at which to poll the email server is extended (step S323). If the polling interval has already been extended, this step is omitted. This makes it possible to delay the timing at which emails including an email sent later at step S329 are received from the email server at step S357 (see FIG. 4) described later. At step S323, an adjustment may be made such that the first polling after the execution of step S323 is performed after the elapse of the extended interval of time.

Then, an email addressed to the printer is generated (step S325), and after a print job is attached to the email (step S327), the email is sent out to a network (step S329).

If settings for email printing have not been made (NO at step S321), it is checked whether a user name has been set for the print job (step S331). If so (YES at step S331), it is checked whether the email address of the user can be identified from the user name, such as by searching an address book retained by the printer or by inquiring an LDAP server set for the printer (step S333).

If the email address of the user has been successfully determined from the user name (YES at step S333), an email addressed to the identified email address of the user is generated (step S335). After a print job is attached to the email (step S337), the resulting email is sent out to a network (step S339).

If a user name has not been set for the print job (NO at step S331), after waiting for a timeout (step S341), the print job is cancelled (step S343).

If it is not possible to identify the email address of the user from the user name (NO at step S333), after waiting for a timeout (step S341), the print job is cancelled (step S343).

Next, referring to FIG. 4, upon arrival of the polling timing, it is checked whether there is any print job saved on the email server (step S351). This can be checked based on whether all the print jobs saved on the email server have been retrieved back from the email server.

If there is any print job saved on the email server, it is checked whether the amount of free space in the spooler area is greater than or equal to a threshold #2 (step S359). In this regard, it is desirable to set the threshold #2 to a value somewhat greater than the threshold #1.

If the amount of free space in the spooler area is greater than or equal to the threshold #2 (YES at step S359), this means that adding at least one or more of currently saved print jobs to the spooler does not cause the amount of free space in the spooler area to become less than the threshold #1 as long as the following condition is met:

threshold #1+total size of emails expected to be received<threshold #2. Accordingly, the process proceeds to step S353 to receive emails. At this time, if it is possible to receive all emails with saved print job data at step S357, this means that the polling interval no longer has to be extended. Therefore, the polling interval that has been extended at step S323 is returned to the original interval (step S361). However, if the polling interval has already been returned to the original interval, this step is omitted.

The process then proceeds from step S361 to step S353. At step S353, the email server is polled. At this time, since the email server has at least an email with a saved print job attached (YES at step S355), at least the email with the saved print job attached is received (step S357). If there is any email that has previously arrived at the email server for the purpose of email printing, such an email is received at step S357.

If there is no print job saved on the email server (NO at step S351), the process directly proceeds from S351 to step S353, and the email server is polled. In this case, no email with a saved job attached is stored on the email server. If there is any email that has been sent to the email server for the purpose of email printing (YES at step S355), such an email is received (step S357).

Alternatively, step S323 may be omitted, and the interval of polling the email server may be extended only on the condition that the amount of free space in the spooler area becomes less than the threshold #1. This ensures that, also for cases where an email addressed to the printer sent from an information processor is not sent to the email server, it is possible to delay the timing when the amount of free space in the spooler area further decreases due to a print job sent from the information processor or clue to a print job that is attached to an email sent to the email server for the purpose of email printing.

Likewise, step S361 may be omitted, and the interval of polling the email server may be returned to the original interval only on the condition that the amount of free space in the spooler area becomes greater than or equal to the threshold #2. This ensures that, also for cases where there is no print job saved on the email server, a print job attached to an email sent to the email server for the purpose of email printing can be sent to the spooler at an earlier time.

### Second Embodiment

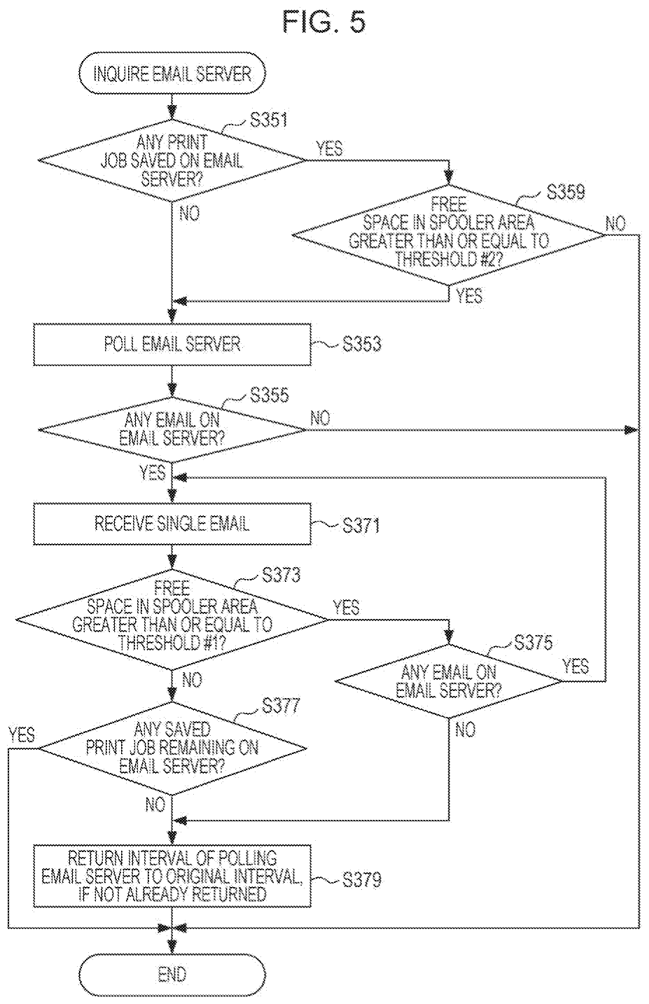

A second embodiment differs from the first embodiment in that the operation performed upon arrival of the polling timing described above with reference to FIG. 4 is changed to the operation performed upon arrival of the polling timing described below with reference to FIG. 5.

Referring to FIG. 5, upon arrival of the polling timing, it is checked whether there is any print job saved on the email server (step S351). This can be checked based on whether all the print jobs saved on the email server have been retrieved back from, the email server.

If there is any print job saved on the email server, it is checked whether the amount of free space in the spooler area is greater than or equal to the threshold #2 (step S359). In this regard, it is desirable to set the threshold #2 to a value somewhat greater than the threshold #1.

If the amount of free space in the spooler area is greater than or equal to the threshold #2 (YES at step S359), this means that adding at least one or more of currently saved print jobs to the spooler does not cause the amount of free space in the spooler area to become less than the threshold #1 as long as the following condition is met:

threshold #1+total size of emails expected to be received<threshold #2. Accordingly, the process proceeds to step S353 to receive emails.

The process then proceeds from step S359 to step S353. At step S353, the email server is polled. At this time, since the email server has at least an email with a saved print job attached (YES at step S355), emails are received one by one while checking that the amount of free space in the spooler area is greater than or equal to the threshold #1 and that there is still any email remaining on the email server (steps S371, S373, and S375).

If there is no longer any email on the email server while the amount of free space in the spooler: area is greater than or equal to the threshold #1 (NO at step S375), this means that the polling interval no longer has to be extended. Accordingly, the interval of polling the email server is returned to the original interval (step S379).

If the amount of free space in the spooler area becomes less than the threshold #1 while there is still any email remaining on the email server (NO at step S373), it is then determined whether there is any print job remaining on the server that has been saved by being attached to an email (step S377). That is, it is determined whether any email with an attached print job that has been sent from the printer exists among emails remaining on the server.

If it is determined that there is no print job remaining on the email server that has been saved by being attached to an email (NO at step S377), this means that the polling interval no longer has to be extended. Accordingly, the interval of polling the email server is returned to the original interval (step S379).

### Third Embodiment

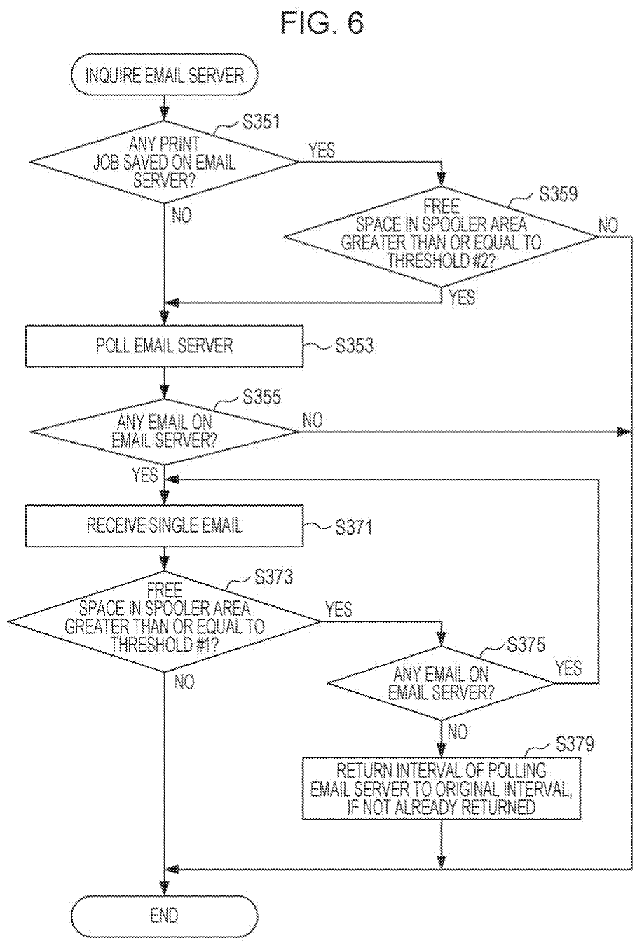

A third embodiment differs from the second embodiment in that the operation performed upon arrival of the polling timing described above with reference to FIG. 5 is changed to the operation performed upon arrival of the polling timing described below with reference to FIG. 6.

Referring to FIG. 6, upon arrival of the polling timing, it is checked whether there is any print job saved on the email server (step S351). This can be checked based on whether all the print jobs saved on the email server have been retrieved back from the email server.

If there is any print job saved on the email server, it is checked whether the amount of free space in the spooler area is greater than or equal to the threshold #2 (step S359). In this regard, it is desirable to set the threshold #2 to a value somewhat greater than the threshold #1 .

If the amount of free space in the spooler area is greater than or equal to the threshold #2 (YES at step S359), this means that adding at least one or more of currently saved print jobs to the spooler does not cause the amount of free space in the spooler area to become less than the threshold #1 as long as the following condition is met:

threshold #1+total size of emails expected to be received<threshold #2. Accordingly, the process proceeds to step S353 to receive emails.

The process then proceeds from step S359 to step S353. At step S353, the email server is polled. At this time, since the email server has at least an email with a saved print job attached (YES at step S355), emails are received one by one while checking that the amount of free space in the spooler: area is greater than or equal to the threshold #1 and that there is still any email remaining on the email server (steps S371, S373, and S375).

If there is no longer any email on the email server while the amount of free space in the spooler area is greater than or equal to the threshold #1 (NO at step S375), this means that the polling interval no longer has to be extended. Accordingly, the interval of polling the email server is returned to the original interval (step S379).

If the amount of free space in the spooler area becomes less than the threshold #1 while there is still any email remaining on the email server (NO at step S373), the process is ended. Accordingly, even if any email with saved print job data does not remain on the email server, if there is any email remaining on the email server that has been sent for the purpose of email printing, the polling interval remains extended. This enhances the tendency of the amount of free space in the spooler area to increase at an earlier time.

### Fourth Embodiment

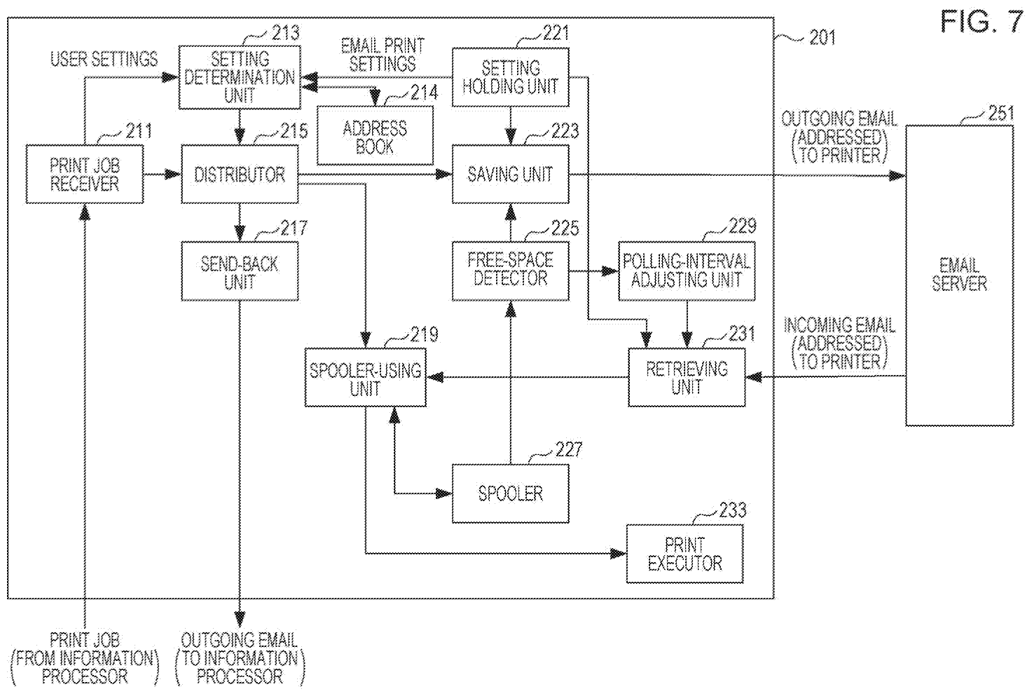

FIG. 7 is a functional block diagram, illustrating a printing system according to a fourth embodiment that includes a printer and an email server connected to the printer.

Referring to FIG. 7, a printer 201 includes a print job receiver 211, a setting determination unit 213, an address book 214, a distributor 215, a send-back unit 217, a spooler-using unit 219, a setting holding unit 221, a saving unit 223, a free-space detector 225, a spooler 227, a polling-interval adjusting unit 229, a retrieving unit 231, and a print executor 233.

The print job receiver 211 receives a print job from an information processor.

The setting determination unit 213 performs determinations performed to allow the distributor 215 to distribute each print job received by the print job receiver 211 to the saving unit 223, the spooler-using unit 219, or the send-back unit 217, based on information such as the state of email print settings in the setting holding unit 221, user settings for the print job received by the print job receiver 211, and the address book 214.

The distributor 215 distributes each print job received by the print job receiver 211 to the saving unit 223, the spooler-using unit 219, or the send-back unit 217 in accordance with the results of determination made by the setting determination unit 213.

The send-back unit 217 attaches a print job distributed from, the distributor 215 to an email, and sends the email to the user of the print job.

The spooler-using unit 219 outputs a print job distributed from the distributor 215, or a print job sent from the retrieving unit 231, to the print executor 233 through the spooler 227. However, if there is no print job in the spooler 227 and there is no print job currently being executed, the spooler-using unit 219 may output an input print job to the print executor 233 directly rather than through the spooler 227.

The setting holding unit 221 holds settings for sending emails addressed to the printer 201 (such, as settings on a sending server), and settings for receiving, via an email server 251, emails addressed to the printer 201 (such as settings for email printing and settings on a receiving server).

The saving unit 223 attaches a print job distributed from the distributor 215 to an email addressed, to the printer 201, and sends out the email to a network via the sending server.

The free-space detector 225 detects the amount of free space in the spooler 227.

The spooler 227 temporarily stores, in a FIFO fashion, each print job sent from the spooler-using unit 219, and outputs the print job when requested from the spooler-using unit 219.

The polling-interval adjusting unit 229 adjusts the polling interval based on information such as the amount of free space in the spooler 227 detected by the free-space detector 225 or other information.

The retrieving unit 231 polls the receiving server-unit of the email server 251 at the polling interval adjusted by the polling-interval adjusting unit 229. Based on the results of polling, the retrieving unit 231 receives an email with an attached print job.

The print executor 233 executes printing based on a print job input from the spooler-using unit 219.

In FIG. 7, the sending server and the receiving server are integrated together as the email server 251.

### Fifth Embodiment

In the above-mentioned embodiments, when the amount of free space for print jobs in the spooler area has decreased, a received print job is temporarily saved to the email server. In particular, since the email printing function already installed in the printer is used, the email server is used as the destination to which to save the print job.

However, alternatively, another kind of server or device located outside the printer may be used as the saving destination. In this case, rather than attaching a print job to an email, the print job may be sent to the server as it is or after being made to conform to the format used for communication with such a server or another device.

Although the above-mentioned embodiments are directed to handling of print jobs, other types of jobs may be handled as well. Even if multiple types of jobs are mixed, such jobs can be handled in the same manner as in the above-mentioned embodiments.

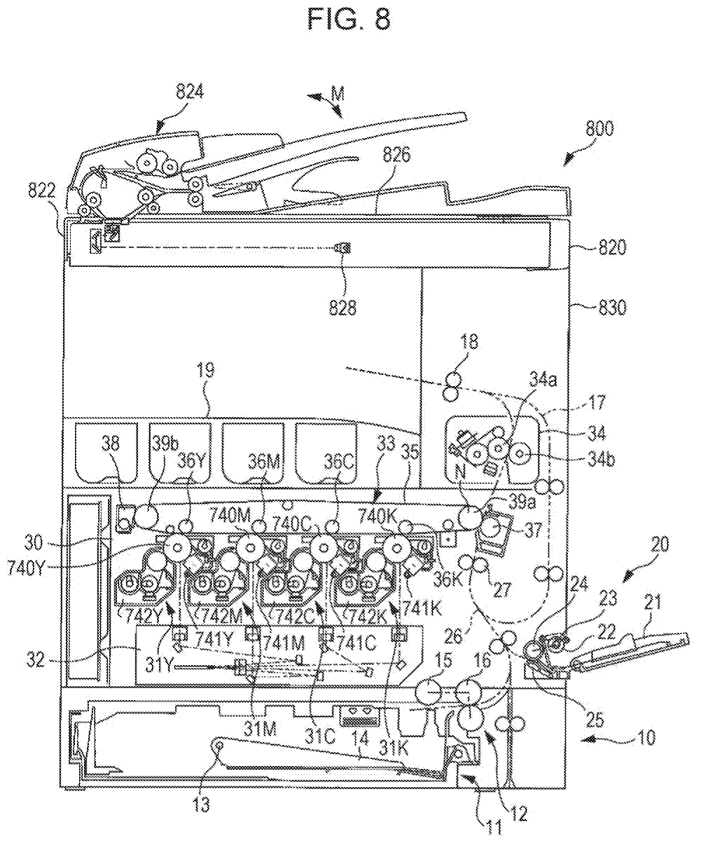

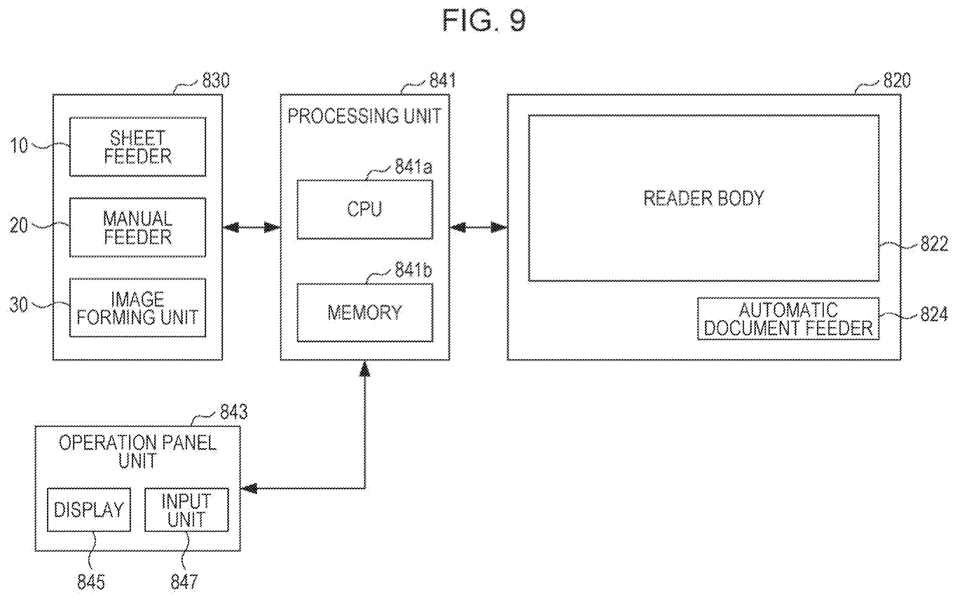

A sixth embodiment relates to the multifunction machine 800 that functions as the printer according to the fourth embodiment. FIGS. 8 and 9 each illustrate the configuration and other features of the multifunction machine 800.

As illustrated in FIGS. 8 and 9, the multifunction machine 800 includes a document reader 820 that reads an image of a document, a multifunction machine body (image forming unit body) 830 that forms an image on a sheet, an operation panel unit 843 used to operate the document reader 820 and the multifunction machine body 830, and a processing unit 841 that controls the document reader 820 and the multifunction machine body 830 based on an operation made with the operation panel unit 843.

In addition to using the document reader 820 singly for reading an image, and in addition to using the multifunction machine body 830 singly for forming an image, it is also possible to make these components operate in conjunction with each other for copying an image. The multifunction machine 800 may include a storage device and a facsimile device (both not illustrated). The storage device is capable of storing an image such as an image read by the document reader 820 or an image received by the facsimile device. The facsimile device is capable of transmitting an image such as an image read by the document reader 820 or an image stored in the storage device, and receiving an image from an external source. The multifunction machine 800 may further include an interface for connecting to a personal computer via a network. The personal computer connected to the multifunction machine 800 can use the functions of the multifunction machine 800 for data that can be managed by the personal computer.

The document reader 820 includes an automatic document feeder (single pass feeder (SPF)) 824 that automatically feeds a document, and a reader body 822 that reads an image of the document. The document reader 820 includes, in addition to the components illustrated in FIG. 9, components that are not illustrated in FIG. 9 but illustrated in FIG. 8. As illustrated in FIG. 8, the reader body 822 is equipped with a document table 826.

The multifunction machine body 830 includes a sheet feeder 10 that feeds a sheet, a manual feeder 20 that allows a sheet to be fed manually, and an image forming unit 30 that forms an image on a sheet fed by the sheet feeder 10 or the manual feeder 20.

The sheet feeder 10 includes a sheet placement unit 11 on which to place sheets, and a separation/feed unit 12 that separates the sheets placed on the sheet placement unit 11 into single sheets and feeds these sheets one by one. The sheet placement unit 11 includes an intermediate plate 14 that rotationally moves about a rotating shaft 13. At the time of feeding sheets, the intermediate plate 14 rotationally moves to lift the sheets upward. The separation/feed unit 12 includes a pickup roller 15 that feeds the sheets lifted up by the intermediate plate 14, and a separation roller pair 16 that separates the sheets fed by the pickup roller 15 into single sheets.

The manual feeder 20 includes a manual tray 21 on which sheets can be placed, and a separation/feed unit 22 that separates the sheets placed on the manual tray 21 into single sheets and feeds these sheets one by one. The manual tray 21 is supported on the multifunction machine body 830 in a manner that allows rotational movement of the manual tray 21. In performing manual feed, the manual tray 21 is moved to be fixed at a predetermined angle to allow placement of sheets on the manual tray 21. The separation/feed unit 22 includes a pickup roller 23 that feeds the sheets placed on the manual tray 21, a separation roller 24 and a separation pad 25 that separate the sheets fed by the pickup roller 23 into single sheets.

The image forming unit 30 includes four process cartridges 31Y to 31K that respectively form yellow (Y), magenta (M), cyan (C), and black (K) images, photoconductor drums 740Y to 740K described later, an exposure device 32 that exposes the respective surfaces of these photoconductor drums to light, a transfer unit (transfer section) 33 that transfers a toner image formed on the surface of each of the photoconductor drums 740Y to 740K to a sheet, and a fixing unit 34 that fixes the transferred toner image onto the sheet. The alphabet (Y, M, C, or K) at the end of each reference sign indicates the corresponding color (yellow, magenta, cyan, or black).

Each of the four process cartridges 31Y to 31K is removable from the multifunction machine body 830 to allow its replacement. The four process cartridges 31Y to 31K are substantially identical in configuration except that the four process cartridges 31Y to 31K form images of different colors. Accordingly, only the configuration of the process cartridge 31Y that forms an yellow (Y) image will be described below, and the configurations of the process cartridges 31M to 31K will not be described.

The process cartridge 31Y includes the photoconductor drum 740Y serving as an image carrier, a charger 741Y that electrically charges the photoconductor drum 740Y, a developing device 742Y that develops an electrostatic latent image formed on the photoconductor drum 740Y, and a drum cleaner that cleans the surface of the photoconductor drum 740Y of any residual toner. The developing device 742Y includes a developing device body (not illustrated in detail) that develops an image on the photoconductor drum 740Y, and a toner cartridge (not illustrated in detail) for supplying toner to the developing device body. The toner cartridge is removable from the developing device body such that, when toner stored in the toner cartridge runs out, the toner cartridge is removed from the developing device body to allow its replacement.

The exposure device 32 includes components such as a light source (not illustrated) that shines a laser beam, and a plurality of mirrors (not illustrated) that direct the laser beam to each of the photoconductor drums 740Y to 740K. The transfer unit 33 includes an intermediate transfer belt 35 that carries a toner image formed on each of the photoconductor drums 740Y to 740K, first transfer rollers 36Y to 36K for a first transfer process that transfers the toner image formed on each of the photoconductor drums 740Y to 740K to the intermediate transfer belt 35, a second transfer roller 37 for a second transfer process that transfers each toner image transferred to the intermediate transfer belt 35 to a sheet, and a belt cleaner 38 that cleans the intermediate transfer belt 35 of any residual toner. The intermediate transfer belt 35 is run between a driving roller 39a and a driven roller 39b. The intermediate transfer belt 35 is pressed against the photoconductor drums 740Y to 740K by the first transfer rollers 36Y to 36K. The second transfer roller 37 nips (sandwiches) the intermediate transfer belt 35 together with the driving roller 39a. At the nip part N, the second transfer roller 37 transfers a toner image carried on the intermediate transfer belt 35 to a sheet. The fixing unit 34 includes a heat roller 34a that applies heat to a sheet, and a pressure roller 34b in press contact with the heat roller 34a.

The operation panel unit 843 includes a display 845 that displays predetermined information, and an input unit 847 with which the user inputs instructions given to the document reader 820 and the multifunction machine body 830. In the sixth embodiment, the operation panel unit 843 is disposed on the front side of the reader body 822. The front side in this case corresponds to the foreground side of FIG. 8, and the back side corresponds to the background side of FIG. 8.

As illustrated in FIG. 9, the processing unit 841 includes a CPU 841a, and a memory 841b. The CPU 841a controls driving of the sheet feeder 10, the manual feeder 20, the image forming unit 30, and the document reader 820. The memory 841b stores information including various programs used for operating the CPU 841a and various information used by the CPU 841a. Based on an operation made on the operation panel unit 843 by the user, the processing unit 841 controls the operations of the sheet feeder 10, the manual feeder 20, the image forming unit 30, and the document reader 820 in an integrated manner such that an image is formed on a sheet.

Next, how an image is formed by the multifunction machine 800 configured as described above (how image formation is controlled by the processing unit 841) will be described. The following describes, by way of example, an exemplary image forming operation in which a document to be read is fed by the automatic document feeder 824, an image of the document is read by the reader body 822, and the resulting image is formed by the image forming unit 30 on a sheet fed by the sheet feeder 10.

When an image formation start signal is transmitted in response to a user's input made on the input unit 847 of the operation panel unit 843, a document to be read that is placed on the automatic document feeder 824 by the user is automatically fed toward a document read position. At the document read position, an image of the document is read by the reader body 822.

When an image of the document is read by the reader body 822, the exposure device 32 irradiates the photoconductor drums 740Y to 740K with the corresponding laser beams based on image information of the document that has been read. At this time, the photoconductor drums 740Y to 740K nave already been charged by chargers 741Y to 741K, respectively. Consequently, as the photoconductor drums 740Y to 740K are irradiated with the corresponding laser beams, the corresponding electrostatic latent images are formed on the photoconductor drums 740Y to 740K. The corresponding electrostatic latent images formed on the photoconductor drums 740Y to 740K are then respectively developed by developing devices 742Y to 742K, Yellow (Y), magenta (M), cyan (C), and black (K) toner images are thus respectively formed on the photoconductor drums 740Y to 740K. The toner images of these colors formed on the photoconductor drums 740Y to 740K are respectively transferred in superimposed relation to the intermediate transfer belt 35 by the first transfer rollers 36Y to 36K. The resulting superimposed toner image (full-color toner image) is transported to the nip part N while being carried by the intermediate transfer belt 35.

In parallel with the above-mentioned image forming operation, sheets placed on the sheet placement unit 11 are fed to a sheet transport path 26 by the pickup roller 15 while being separated into single sheets by the separation/feed unit 12. Then, each sheet is corrected for skew by a registration roller pair 27 located upstream of the nip part N with respect to the direction of sheet transport, and transported to the nip part N at predetermined transport timing. As the sheet being transported reaches the nip part N, a full-color toner image carried by the intermediate transfer belt 35 is transferred to the sheet by the second transfer roller 37.

As the sheet with the transferred toner image is subjected to heat and pressure in the fixing unit 34, the toner image is fused and fixed onto the sheet. The resulting sheet is discharged to the outside of the printer by a discharge roller pair 18. The sheet discharged to the outside of the printer is placed onto a discharged-sheet placement unit 19.

If an image is to be formed on both sides (first side and second side) of a sheet, before a sheet with an image formed on the first side is discharged to the outside of the printer, the discharge roller pair 18 is rotated in reverse to transport the sheet to a duplex transport path 17. The sheet is then transported to the image forming unit 30 again via the duplex transport path 17. Subsequently, an image is formed on the second side of the sheet in the same manner as the first side, and the resulting sheet is discharged to the outside of the printer. The sheet discharged to the outside of the printer is placed onto the discharged-sheet placement unit 19.

The above-mentioned printer can be implemented by hardware, software, or a combination thereof. Likewise, the printing method performed by the printer can be implemented by hardware, software, or a combination thereof. As used herein, the expression “implemented by software” means being implemented by a computer reading and executing a program.

The program can be stored and supplied to a computer by using various types of non-transitory computer readable media. Examples of non-transitory computer readable media include various types of tangible storage media. Examples of non-transitory computer readable media include a magnetic storage medium (e.g., a flexible disk, a magnetic tape, or a hard disk drive), a magneto-optical storage medium (e.g., a magneto-optical disc), a CD read only memory (CD-ROM), a CD-R, a CD-R/W, and a semiconductor memory (e.g., a mask ROM, a programmable ROM (PROM), an erasable PROM (EPROM), a flash ROM, or a random access memory (RAM)). Alternatively, the program may be supplied to a computer by using various types of transitory computer readable media. Examples of transitory computer readable media include an electrical signal, an optical signal, and an electromagnetic wave. Such a transitory computer readable medium allows the program to be supplied to a computer via wired communication paths, such as an electric wire and an optical fiber, or via wireless communication paths.

The present disclosure may be practiced in various forms without departing from its spirit and scope. Accordingly, the above-mentioned embodiments are illustrative only and not to be construed as limiting. The scope of the present disclosure is defined by the claims and by no means restricted by the specification. Further, all modifications and alterations that fall within the scope of the claims and equivalents thereof are to be encompassed by the scope of the present disclosure.

The present disclosure can be employed for printing. Further, the present disclosure can be employed, to control jobs.

The present disclosure contains subject matter related to that disclosed in Japanese Priority Patent Application JP 2018-141295 filed in the Japan Patent Office on Jul. 27, 2018, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A job manager comprising:
a saving section that, if a job is received while an amount of free space for a job in a spooler area is less than a first predetermined value, saves the job to another device;
a retrieving section that, in accordance with a predetermined polling interval, retrieves the job temporarily saved on the other device back to the job manager from the other device; and
a job output section that outputs, to an executing device, the job retrieved back from the other device.

2.The job manager according to claim 1,
wherein the saving section temporarily saves the job to the other device as a job addressed to the job manager, and
wherein the retrieving section retrieves the job addressed to the job manager back to the job manager from the other device.

3. The job manager according to claim 1, further comprising
a polling-interval adjusting section that adjusts the polling interval in accordance with an amount of free space in the spooler area,
wherein the predetermined polling interval is a polling interval adjusted by the polling-interval adjusting section.

4. The job manager according to claim 3,
wherein in response to at least one trigger, the polling-interval adjusting section extends the polling interval from an interval less than the predetermined polling interval to the predetermined polling interval, the at least one trigger being that an amount of free space in the spooler area becomes less than the first predetermined value.

5. The job manager according to claim 3,
wherein in response to a trigger, the polling-interval adjusting section extends the polling interval from an interval less than the predetermined polling interval to the predetermined polling interval, the trigger being that an amount of free space in the spooler area becomes less than the first predetermined value and that the saving section determines to save the job to the other device.

6. The job manager according to claim 4,
wherein in response to at least one trigger, the polling-interval adjusting section returns the polling interval extended to the predetermined polling interval to an original polling interval, the at least one trigger being that an amount of free space in the spooler area becomes a second predetermined value greater than the first predetermined value.

7. The job manager according to claim 4,
wherein in response to a trigger, the polling-interval adjusting section returns the polling interval extended to the predetermined polling interval to an original polling interval, the trigger being that an amount of free space in the spooler area becomes a second predetermined value greater than the first predetermined value when the job is being saved on the other device.

8. The job manager according to claim 4,
wherein in response to a trigger, the polling-interval adjusting section returns the polling interval extended to the predetermined polling interval to an original polling interval, the trigger being that the job is no longer present on the other device.

9. The job manager according to claim 1, further comprising
a job send-back section that, if the saving section is unable to save the job to the other device, sends back the job via an email addressed to a user corresponding to the job.

10. The job manager according to claim 9,
wherein the job send-back section provides notification via an email addressed to the user, the notification notifying that printing based on the job has failed.

11. The job manager according to claim 1, further comprising
a notifier that, if the saving section is unable to save the job to the other device, provides notification via an email addressed to a user corresponding to the job, the notification notifying that printing based on the job has failed.

12. The job manager according to claim 1, further comprising
a spooler-using section that, while an amount of free space in the spooler area is greater than or equal to the first predetermined value, supplies a received job and the job retrieved back from the other device to the executing device after passing the job through the spooler area.

13. The job manager according to claim 1,
wherein the job is a print job, the executing device is a print executor of a printer, and the other device is an email server.

14. A printer comprising:
the job manager according to claim 13; and
the print executor.

15. A multifunction machine that functions as the printer according to claim 14.

16. A printing system comprising:
the printer according to claim 14; and
the email server.

17. A job management system comprising:
the job manager according to claim 1; and
the other device.

18. A job management method comprising:
if a job is received while an amount of free space for a job in a spooler area is less than a first predetermined value, saving the job to another device;
in accordance with a predetermined polling interval, retrieving the job temporarily saved on the other device back from the other device; and
outputting, to an executing device, the job retrieved back from the other device.

19. A storage medium, storing a program, the program causing a computer to function as the job manager according to claim 1.
